(19) United States
(12) Patent Application Publication
(10) Pub. No.: US 2026/0147795 A1
(43) Pub. Date: May 28, 2026

(54) QUERY-AWARE MULTI-STAGE GRAPH CONTROL FOR RETRIEVAL-AUGMENTED GENERATION SYSTEMS

(71) Applicant: Intel Corporation, Santa Clara, CA (US)

(72) Inventors: Peixi Xiong, Hillsboro, OR (US); Chaunte Lacewell, Hillsboro, OR (US); Sameh Gobriel, Dublin, CA (US); Nilesh Jain, Portland, OR (US)

(73) Assignee: Intel Corporation, Santa Clara, CA (US)

(21) Appl. No.: 19/451,239

(22) Filed: Jan. 16, 2026

(51) Int. Cl. G06F 16/332; G06F 16/383

(52) U.S. Cl. CPC G06F 16/3328; G06F 16/383

(57) ABSTRACT

Building a robust and effective knowledge graph-based retrieval-augmented generation (RAG) system has two technical challenges: (1) constructing high-quality subgraphs and (2) pruning subgraphs without losing critical information. To address these challenges, a multi-stage framework involving enhanced initial node retrieval and query-aware subgraph pruning can be implemented. Initial node retrieval can include fusing results from vector similarity search and symbolic text search to produce initial nodes that are more robust to lexical variation. Query-aware subgraph pruning can include calculating node prizes and edge prizes based on query-conditioned, learnable prize parameters to produce compact and task-relevant subgraphs. The pruned subgraphs and the query are used as inputs in a joint graph neural network and large language model inference process to produce an evidence-grounded answer to the query.

### BACKGROUND

Retrieval-Augmented Generation (RAG) is a framework in machine learning (ML) that combines information retrieval techniques with generative models to improve the accuracy and relevance of automated responses. In a RAG system, a user's query is used to search a large corpus of documents or data sources, retrieving the most relevant pieces of information. These retrieved documents are then provided as additional context to a large language model (LLM), which generates a response that is grounded in the retrieved content. This approach allows RAG systems to leverage both the broad knowledge encoded in generative models and the specificity of external, up-to-date information, making them especially effective for tasks that require factual accuracy, domain expertise, or context-sensitive answers. RAG has become a useful technique for applications such as question answering, technical support, and enterprise search, where combining retrieval and generation leads to more reliable and context-aware outputs.

### BRIEF DESCRIPTION OF THE DRAWINGS

Embodiments are readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a query-aware multi-stage graph control system and a graph neural network and large language model joint inference system, according to some embodiments of the disclosure.

FIG. 2 illustrates operations performed in the query-aware multi-stage graph control system, according to some embodiments of the disclosure.

FIG. 3 illustrates operations performed in an initial node retrieval operation, according to some embodiments of the disclosure.

FIG. 4 illustrates operations performed in an adaptive subgraph construction operation, according to some embodiments of the disclosure.

FIG. 5 illustrates operations performed in a subgraph pruning operation, according to some embodiments of the disclosure.

FIG. 6 illustrates operations performed in the graph neural network and large language model joint inference system, according to some embodiments of the disclosure.

FIG. 7 depicts a flow diagram illustrating a method for, according to some embodiments of the disclosure.

FIG. 8 is a block diagram of an exemplary computing device, according to some embodiments of the disclosure.

### DETAILED DESCRIPTION

### Overview

RAG has emerged as a powerful paradigm to enhance LLMs by grounding their responses in external knowledge sources. A RAG system retrieves semantically relevant passages from a text corpus and conditions generation of an answer on this retrieved evidence. While effective in open-domain question answering and knowledge-intensive tasks, conventional RAG systems remain limited by their reliance on unstructured text retrieval, which often struggle to capture complex relational information or multi-hop reasoning chains.

To address these limitations, recent research has introduced GraphRAG, which integrates structured knowledge graphs into the retrieval process. GraphRAG combines LLMs with knowledge graphs to improve question answering and reasoning. When a user asks a question, referred to as a query, the GraphRAG system first identifies relevant entities/nodes and relationships in a structured graph database. The system then assembles a subgraph having the most pertinent information for the query using the entities/nodes. This subgraph is processed using graph neural networks to capture connections and context, and the results are integrated with an LLM to generate a response or an answer to the query. By leveraging entities/nodes, relations, and graph topology, GraphRAG enables more interpretable reasoning and supports richer query understanding. However, incorporating graph structures also introduces new challenges. Specifically, GraphRAG systems must efficiently identify task-relevant subgraphs from large-scale graphs, balance semantic coverage against noise, and interface structured graph embeddings with unstructured textual reasoning in LLMs. These challenges often result in brittle retrieval pipelines or high computational overheads, limiting their applicability in real-world domains such as biomedical, scientific research, technical domains, engineering, healthcare and clinical decision support, legal analysis, regulatory analysis, policy analysis, web search, open-domain question answering, educational knowledge management, and enterprise knowledge understanding.

The robustness and effectiveness of GraphRAG can be improved by systematically addressing two core challenges. The first challenge relates to constructing high-quality initial candidate subgraphs that capture both lexical precision and semantic coverage. The first challenge arises from the tendency of vector-based retrieval to suffer from embedding drift and lexical mismatch, which can lead to incomplete or noisy seed sets, referred to as initial nodes. The second challenge relates to pruning these candidates into compact, task-relevant substructures without losing critical information. The second challenge lies in controlling graph complexity, where overly dense candidate graphs hinder reasoning efficiency, yet overly aggressive pruning risks discarding crucial relational evidence.

To address these challenges, a multi-stage framework involving enhanced initial node retrieval and query-aware subgraph pruning can be implemented. Initial node retrieval can include fusing results from vector similarity search and symbolic text search to produce initial nodes that are more robust to lexical variation. The retrieval strategy fuses dense semantic embeddings with symbolic entity recognition. Query-aware subgraph pruning can include calculating node prizes and edge prizes based on query-conditioned, learnable prize parameters to produce compact and task-relevant subgraphs. The learnable prize parameters can yield prize assignments and calculations that are conditioned on both structural features and query semantics. The prizes calculated based on the learnable parameters are used as part of Prize-Collecting Steiner Tree (PCST) formulation to prune the subgraph.

The pruned subgraphs and the query are used as inputs in a joint graph neural network and large language model (GNN-LLM) inference process to produce an evidence-grounded answer to the query. The model inference process, which involves a graph neural network encoder and an LLM, can capture relational evidence in the pruned subgraph into the same representational space as the LLM, enabling graph-text fusion and optionally chain-of-thought guided reasoning.

In some embodiments, the enhanced initial node retrieval process uses both vector similarity search and symbolic text search to find relevant nodes in a knowledge graph based on a query. The process combines these results to select initial nodes and builds a subgraph around the initial nodes. The query-aware subgraph pruning process then calculates special prize parameters for the subgraph based on the query. These prizes, calculated based on the prize parameters, help the process decide which nodes and connections are most important. The process then prunes the subgraph using the special prize parameters and outputs a pruned subgraph that focuses on the most relevant information. Finally, a joint GNN-LLM process uses both the query and the pruned subgraph to generate an answer.

In some embodiments, the enhanced initial nodes retrieval process extracts key entities from the query and uses a transformer-based neural network to assign attention scores to these entities. These scores help the enhanced initial nodes retrieval process better calculate how well different nodes in the knowledge graph match the query by taking into account that not all entities are to be treated equally in importance and attention, thereby improving the accuracy of the symbolic text search.

In some embodiments, when combining results from vector similarity and symbolic text searches, the enhanced initial nodes retrieval process calculates a fused score for each node by taking the lower (minimum) of the two search scores. This conservative approach ensures that only nodes strongly supported by both search methods are selected as initial nodes.

In some embodiments, the enhanced initial nodes retrieval process can adjust how much it relies on vector similarity versus symbolic text search by changing the weights assigned to each score. These weights can be tuned to prioritize either precision (fewer, more accurate results) or recall (more, broader results), depending on the needs of the task. In some embodiments, the fused score for each node can also take into account the node's rank position and/or whether it appears in both search results. Taking additional information into account helps the enhanced initial nodes retrieval process further refine which nodes are most relevant to the query. In some embodiments, the enhanced initial nodes retrieval process can use a transformer-based neural network model to further rank and select initial nodes by considering both the query and detailed descriptions of the initial nodes.

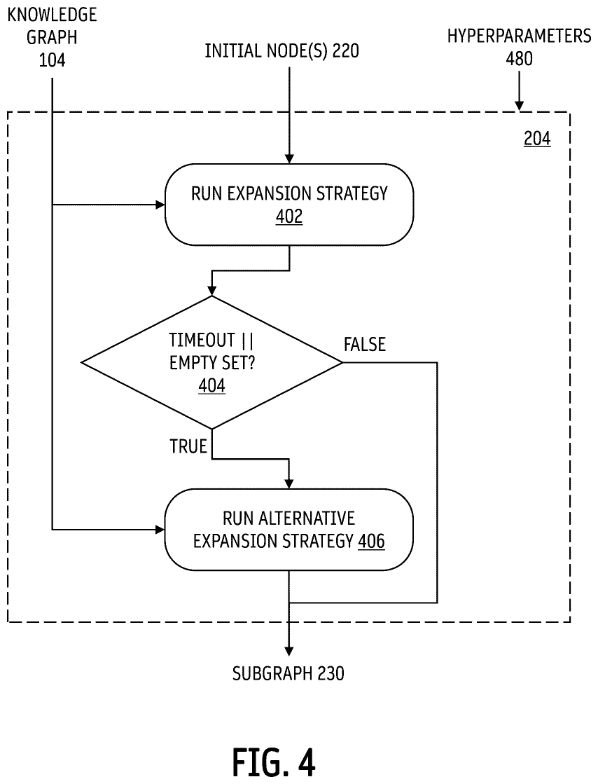

In some embodiments, an adaptive subgraph construction process (e.g., as illustrated in FIG. 4) builds the subgraph using a chosen expansion strategy, but if certain fallback conditions occur, such as a timeout or no results (e.g., an empty result set), the process switches to an alternative strategy to ensure a useful subgraph is constructed.

In some embodiments, the query-aware subgraph pruning process determines the prize parameters for subgraph pruning by inputting the query into a model trained on the knowledge graph using contrastive learning. The model can be trained using a training set of one or more queries (e.g., the current query) and positive and negative examples from the knowledge graph for the set of one or more queries. Using learnable prize parameters allows the query-aware subgraph pruning process to adaptively decide which parts of the subgraph are most relevant in view of the query and the knowledge graph. In some embodiments, the query-aware subgraph pruning process extracts entities from the query and uses both the query and these entities as input into a model trained with contrastive learning. Using the extracted entities and/or query allows the model to generate prize parameters that are tailored to the specific query and entities involved. In some embodiments, the prize parameters used for subgraph pruning, e.g., following the PCST formulation, include a base prize magnitude, an exponential decay rate, an edge reward multiplier, and a query-specific boosting factor. These parameters, which can be produced by the model based on the query, help the system fine-tune which nodes and edges are kept in the pruned subgraph based on the query and the domain (e.g., the knowledge graph).

It is envisioned that the prize parameters and/or subgraph pruning decisions can be predicted using a model trained using machine learning. Besides contrastive learning, other machine learning techniques, such as reinforcement learning, meta-learning, few-shot learning, probabilistic graphical models, Bayesian machine-learning techniques, supervised learning, unsupervised learning, semi-supervised learning, can be used. In some embodiments, ensemble learning techniques involving multiple models and fusing outputs through, e.g., averaging, voting, and confidence-weighted fusion can be used to predict the prize parameters and/or subgraph pruning decisions.

In some evaluations, implementing the query-aware multi-stage graph control system on a benchmark dataset for structured question answering over knowledge graphs shows that the overall knowledge graph RAG system can outperform other baseline systems, such as BM25 and ColBERTv2. The graph control system enables the RAG system to achieve the best overall balance against other baseline systems, obtaining the highest F1, precision, recall, exact hit metrics across multiple thresholds, and the strongest mean reciprocal rank (MRR). These results suggest that the graph control system yields a more consistent improvement across both precision- and recall-oriented measures and metrics.

### Improved Knowledge Graph-Based RAG System for Structured Question and Answering

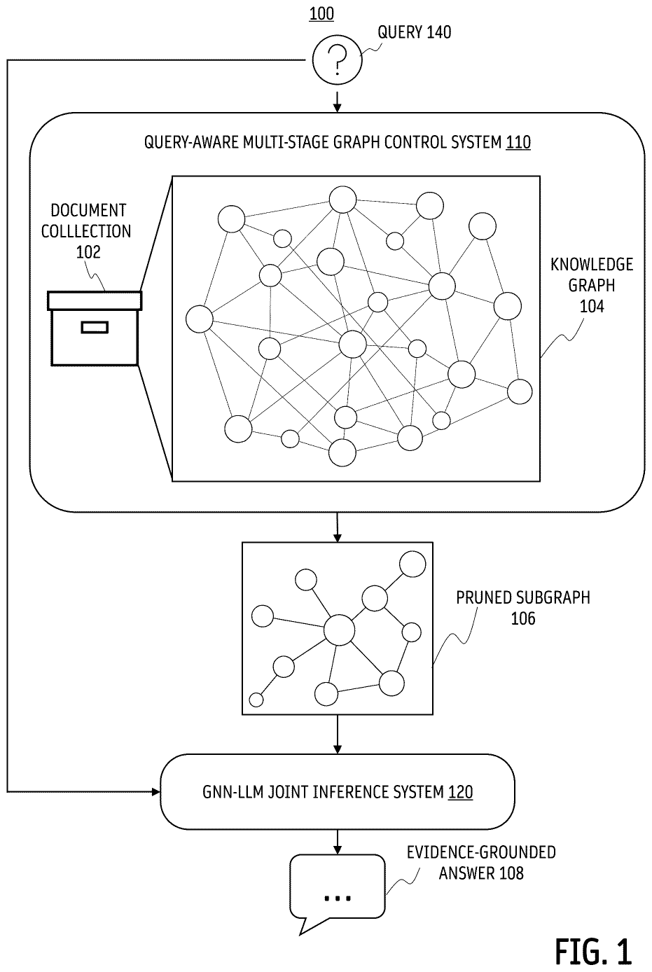

FIG. 1 illustrates query-aware multi-stage graph control system 110 and GNN-LLM joint inference system 120, according to some embodiments of the disclosure. Knowledge graph-based RAG system 100 includes one or more of: query-aware multi-stage graph control system 110 and GNN-LLM joint inference system 120.

Knowledge graph-based RAG system 100 implements query-aware multi-stage graph control system 110 to produce a high-quality, pruned subgraph 106 based on query 140. Query-aware multi-stage graph control system 110 receives query 140. Query 140 is a structured request for information, typically expressed as a question or a set of keywords, that guides a search or retrieval process. Query 140 defines what the user or an application wants to find within a dataset, database, or document collection 102. Query 140 can be simple or complex, specifying entities, relationships, or constraints.

In one example, query 140 includes a query ID and a query text:

Query ID: 12345
Query Text: “What genes are associated with Alzheimer's disease and can
be targeted by donepezil treatment?”

Query-aware multi-stage graph control system 110 includes or has access to knowledge graph 104 generated from document collection 102.

In some embodiments, knowledge graph 104 can be generated from document collection 102 by first parsing each document to extract entities (such as people, organizations, concepts, or technical terms) and the relationships between them using natural language processing and information extraction techniques. These entities become the nodes of knowledge graph 104, while the relationships, e.g., identified through co-occurrence, semantic analysis, or explicit references, form the edges of knowledge graph 104. The process can involve enriching the extracted data with metadata, linking entities to external ontologies, and normalizing terms for consistency. As documents in document collection 102 are processed, knowledge graph 104 grows to represent the interconnected structure of knowledge within the corpus, enabling multi-hop reasoning, semantic search, and contextual retrieval for downstream applications like retrieval-augmented generation or enterprise search.

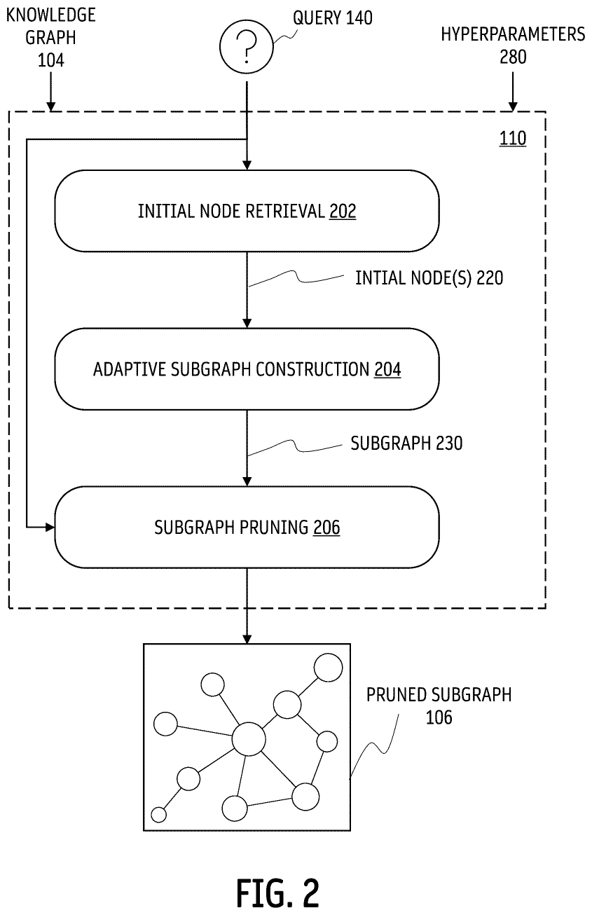

As detailed in FIGS. 2-5, query-aware multi-stage graph control system 110 enriches retrieval with structured reasoning. Query-aware multi-stage graph control system 110 can parse the user query to extract salient entities. Query-aware multi-stage graph control system 110 runs dual retrieval, which involves dense vector similarity and a focused/attentional text search. Query-aware multi-stage graph control system 110 then fuses these signals conservatively (e.g., weighted/min scoring and optional LLM re-ranking) to produce a high-quality seed set of initial nodes. Next, query-aware multi-stage graph control system 110 constructs an adaptive local subgraph around those seeds (e.g., preferring 2-hop/2-path expansions with fallbacks for coverage and latency). Query-aware multi-stage graph control system 110 prunes that subgraph with a learnable PCST formulation that assigns query-conditioned node/edge “prizes” (base prize, decay with distance, edge multipliers, query boosts) to keep only the most relevant structure as pruned subgraph 106.

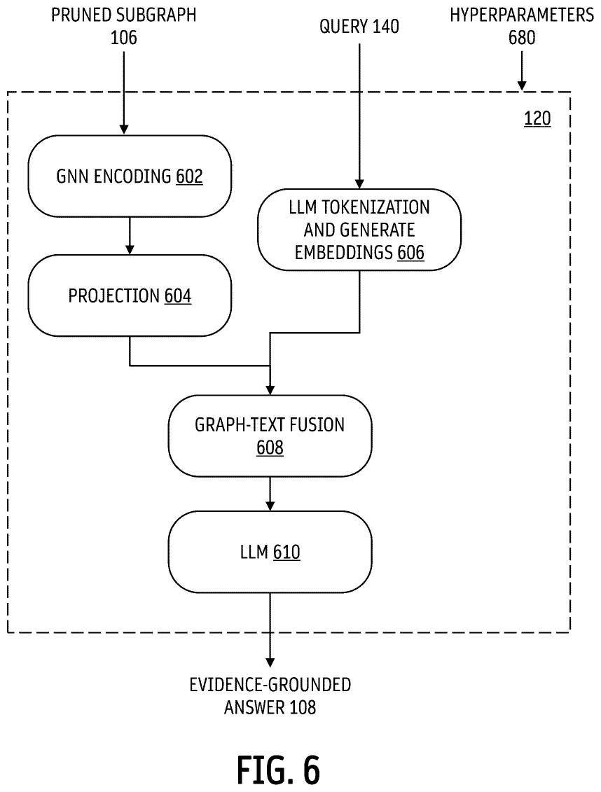

GNN-LLM joint inference system 120 encodes pruned subgraph 106, projects graph embeddings into the LLM space, fuses the projected graph embeddings with embeddings of query 140, and generates evidence-grounded answer 108. Additional implementation details are illustrated and described in FIG. 6.

Together, query-aware multi-stage graph control system 110 and GNN-LLM joint inference system 120 form a unified pipeline that grounds LLMs in structured graph evidence, enabling retrieval-augmented reasoning that balances semantic coverage, interpretability, and domain robustness.

### Query-Aware Multi-Stage Graph Control System

Despite the advances of knowledge graph-based RAG systems in recent works, several fundamental challenges exist. Initial node retrieval is often limited to embedding similarity or string-based entity linking, lacking query-awareness to filter semantically weak seeds. Subgraph construction relies on fixed-hop or rule-based expansion, which can lead to redundant or tangential nodes. Lastly, subgraph pruning is often applied via static top-K filters or post-hoc graph neural network (GNN) scoring. Low-quality pruned subgraphs limit the model's ability to focus on relevant evidence, especially in heterogeneous or dense graphs. To address these challenges, the query-aware multi-stage graph control system implements improvements on one or more of seed retrieval, subgraph construction, and subgraph pruning mechanisms.

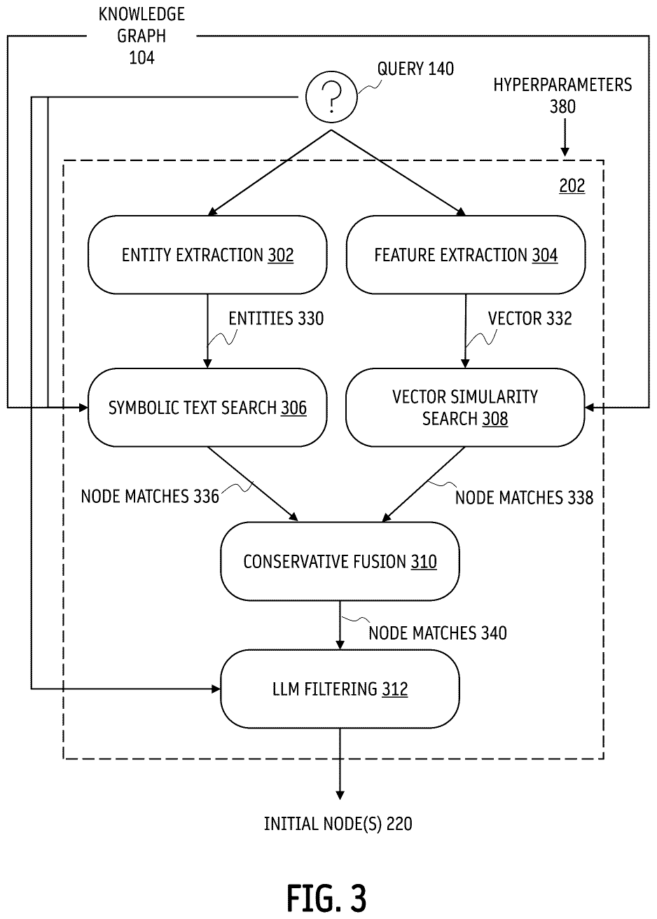

FIG. 2 illustrates operations performed in query-aware multi-stage graph control system 110, according to some embodiments of the disclosure. Query-aware multi-stage graph control system 110 receives query 140 and knowledge graph 104. Query-aware multi-stage graph control system 110 may receive one or more hyperparameters 280. One or more hyperparameters 280 may include one or more tunable settings that govern key behaviors, such as the number of nodes retrieved, the maximum hops for subgraph expansion, and thresholds for pruning. One or more hyperparameters 280 can determine how broadly or narrowly the system explores and refines the knowledge graph in response to a query. Adjusting these values directly impacts retrieval quality, computational efficiency, and the relevance of generated answers. Specific examples of one or more hyperparameters 280 are described in FIGS. 3-5.

Query-aware multi-stage graph control system 110 includes three operations to progressively refine evidence from large knowledge graphs, e.g., knowledge graph 104, and generates pruned subgraph 106, which can be used in a joint GNN-LLM RAG process. The operations include initial node retrieval 202, adaptive subgraph construction 204, and subgraph pruning 206 with learnable parameters.

Initial node retrieval 202 involves a hybrid retrieval process that combines dense semantic encoders with symbolic lexical matching, yielding an initial candidate node set, referred to as one or more initial nodes 220, that is both semantically comprehensive and lexically precise. In some embodiments, in initial node retrieval 202, query 140 is parsed to extract entities. Vector similarity and symbolic text search results are fused conservatively, optionally re-ranked by an LLM to produce one or more initial nodes 220. Details of initial node retrieval 202 are described and illustrated in FIG. 3.

Adaptive subgraph construction 204 involves expanding the initial nodes into one or more localized subgraphs through policy-driven exploration of one-hop and two-hop relational paths, with adaptive fallback mechanisms to ensure robustness under computational or coverage constraints. In some embodiments, a candidate subgraph, referred to as subgraph 230, is assembled around one or more initial nodes 220 with fallback mechanisms to ensure coverage of relevant relations. Details of adaptive subgraph construction 204 are described and illustrated in FIG. 4.

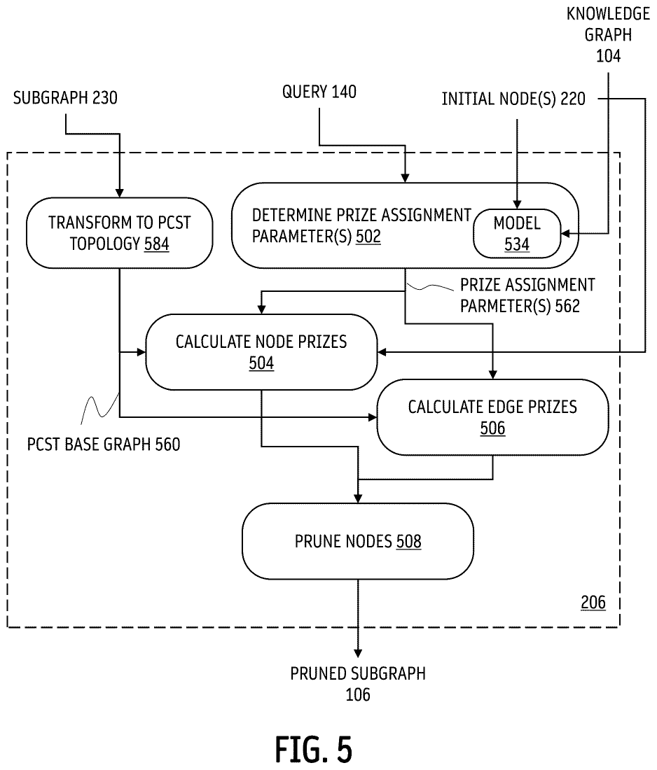

Subgraph pruning 206 with learnable parameters formulates subgraph selection as a learnable Prize-Collecting Steiner Tree problem, where query-conditioned parameters determine node and edge rewards, producing compact yet semantically salient subgraphs, referred to as pruned subgraph 106. In some embodiments, subgraph 230 is pruned via a learnable Prize-Collecting Steiner Tree formulation, where node and edge prizes are adaptively assigned using query-conditioned parameters (base prize, decay rate, edge multiplier, query boost). Pruned subgraph 106 is a compact subgraph that balances task relevance with structural parsimony. Details of subgraph pruning 206 with learnable parameters are described and illustrated in FIG. 5.

### Initial Node Retrieval

FIG. 3 illustrates operations performed in initial node retrieval 202, according to some embodiments of the disclosure.

Initial node retrieval 202 includes entity extraction 302. Entity extraction 302 receives query 140 and outputs one or more entities 330. In one example, the following one or more entities 330 can be extracted from query 140:

Example: Biomedical Entity Extraction
genes: APOE, APP
diseases: alzheimer, alzheimer's disease
drugs: donepezil

Entity extraction 302 can implement a semantic parsing stage that extracts salient entity candidates from query 140 using rule-based or pre-trained domain-specific recognizers. Entity extraction 302 in initial node retrieval 202 can identify and isolate one or more entities 330, e.g., key concepts, names, or technical terms, from query 140. One or more entities 330 act as anchors to constrain the search space in one or more subsequent retrieval stages, or serve as anchors for searching relevant nodes in knowledge graph 104.

Initial node retrieval 202 can include feature extraction 304. Feature extraction 304 receives query 140 and outputs vector 332. Feature extraction 304 of query 140 can include generating a feature vector embedding or a vector representation, referred to as vector 332, that numerically represents or encodes the salient characteristics of query 140 for use in one or more subsequent stages. Generating vector 332 may include tokenizing and normalizing query 140, and inputting the tokens into a pre-trained encoder, such as a transformer-based neural network, to produce token-level embeddings. These embeddings are aggregated, for example by pooling or selection of a designated token, into a fixed-length feature vector, e.g., vector 332, that may be further normalized or supplemented with auxiliary features. The resulting vector 332 enables efficient and accurate similarity matching against stored graph node or document embeddings, thereby facilitating precise retrieval and reasoning within a knowledge graph framework.

Initial node retrieval 202 performs dual-path retrieval: symbolic text search 306 and vector similarity search 308. This hybrid strategy yields two complementary candidate lists, e.g., one emphasizing semantic coverage, the other lexical precision.

Vector similarity search 308 can retrieve the top-K nearest nodes from a pre-encoded graph node index. Initial node retrieval 202 may determine, using vector similarity search 308, one or more nodes of knowledge graph 104 that match query 140. The one or more nodes of knowledge graph 104 that match query 140, e.g., the top-K nodes with the highest matching scores or nodes with matching scores that exceed a threshold score, are referred to and shown as node matches 338.

Vector similarity search 308 for finding matching nodes in knowledge graph 104 involves comparing the feature vector embedding of query 140, e.g., vector 332, to the embeddings of nodes within knowledge graph 104. Each node in knowledge graph 104 is represented by its own vector, capturing its semantic and relational attributes. Vector similarity search 308 calculates vector similarity scores, using metrics such as cosine similarity, between vector 332 and each node's vector, ranking nodes by how closely they match the query's meaning. Nodes with the highest similarity scores (e.g., top-K nodes) are selected as the most relevant matches, enabling precise and context-aware retrieval within knowledge graph 104.

In one example, vector similarity search 308 may identify one or more nodes as follows:

Example: Vector Similarity Search
node ID, node name, similarity score
(501234, APOE gene, 0.8234),
(502156, Alzheimer's disease, 0.8012),
(503789, Donepezil, 0.7891),
(504123, Amyloid beta, 0.7654),

| | |
|---|---|
| ... | ... |

(508456, Neurodegeneration, 0.6987)

Symbolic text search 306 can implement a symbolic retriever, which identifies top-K nodes with high lexical overlap or substring matches based on the extracted entities, e.g., one or more entities 330. Different implementations of symbolic text search 306 are envisioned. Initial node retrieval 202 may determine, using symbolic text search 306, one or more further nodes of knowledge graph 104 that match query 140. Symbolic text search 306 may identify the one or more further nodes using one or more entities 330. The one or more further nodes of knowledge graph 104 that match query 140, e.g., top-K nodes with the highest matching scores or nodes with matching scores exceeding a threshold score, are referred to and shown as node matches 336.

In some embodiments, symbolic text search 306 performs matching of query terms and extracted entities (e.g., one or more entities 330) against the textual content or labels of nodes in knowledge graph 104. This approach uses rule-based methods, such as substring matching, exact keyword comparison, or regular expressions, to identify nodes whose names or descriptions have the relevant entities. By focusing on lexical overlap and explicit term presence, symbolic search efficiently retrieves nodes that are textually aligned with the query 140. This method is fast and interpretable, making it suitable for scenarios where precision and transparency in matching are prioritized.

In some embodiments, symbolic text search 306 uses an attention-based mechanism. Symbolic text search 306 may use query 140 and/or one or more entities from the query (e.g., one or more entities 330) and input query 140 and/or one or more entities 330 into a transformer-based neural network to obtain attention scores for each entity of one or more entities 330. These attention scores quantify the relevance or importance of each entity within the context of query 140. Symbolic text search 306 can calculate matching scores for nodes in knowledge graph 104 by combining the presence of one or more entities 330 in node labels or descriptions with their corresponding attention scores, effectively weighting node matches according to the semantic focus of query 140. This approach enables symbolic text search 306 to prioritize nodes that not only contain the relevant entities (e.g., one or more entities 330) but also align with the intent of query 140 as determined by the transformer's attention mechanism.

In one example, symbolic text search 306 may identify one or more nodes as follows:

Example: Symbolic Text Search
node ID, node name, number of matched term(s) or symbolic text search
score
(501234, APOE gene, 3),
(502156, Alzheimer's disease, 3),

| | |
|---|---|
| ... | ... |

(508456, Neurodegeneration, 1)

To unify node matches 336 and node matches 338, conservative fusion 310 implements a conservative score-level fusion strategy to produce node matches 340. In some embodiments, node matches 340 are used directly as one or more initial nodes 220. In some embodiments, node matches 340 may be processed by LLM filtering 312, which then produces one or more initial nodes 220. Conservative fusion 310 may determine one or more initial nodes (referred to and shown as node matches 340 or one or more initial nodes 220) based on the one or more nodes (referred to and shown as node matches 338) and the one or more further nodes (referred to and shown as node matches 336). Conservative fusion 310 may determine the one or more initial nodes based on one or more composite/fused scores calculated based on the matching score(s) of node matches 338 and the matching score(s) of node matches 336. Each node in node matches 336 and node matches 338 is assigned a composite/fused score, which can reflect one or more of: its retrieval source (dense or symbolic), a rank position, and overlap status. This approach helps prioritize nodes that are not only relevant according to individual metrics but also consistently prominent across different retrieval strategies, resulting in more robust and reliable selection of candidates for downstream reasoning.

In some embodiments, conservative fusion 310 calculates a fused score of an initial node of the one or more initial nodes (e.g., node matches 340 or one or more initial nodes 220) based on a minimum of a vector similarity search score corresponding to the initial node (“vector_score”) and a symbolic text search score corresponding to the initial node (“symbolic_text_score”). The fused score can be represented as: score=min (vector_score, symbolic_text_score).

In some embodiments, the vector similarity search score is weighted according to a first weight (“w1”) and the symbolic text search score is weighted according to a second weight (“w2”). The fused score can be represented as score=min (w1*vector_score, w2*symbolic_text_score). In one example, w1 is equal to 0.7 and w2 is equal to 0.3. The first weight and the second weight are adjustable to prioritize precision or recall. Tunable weighting parameters allow initial node retrieval 202 to prioritize precision or recall depending on downstream task requirements. For example, a node like “APOE” that appears in both channels (e.g., in node matches 336 and node matches 338) may be promoted due to its high semantic similarity and lexical match, whereas nodes like “Amyloid beta” may surface due solely to embedding relevance.

In some embodiments, conservative fusion 310 calculates the fused score of the node further based on one or more of: a rank position of the initial node, and an overlap status of the initial node. In some embodiments, the rank position can be used in the fused score by assigning additional weight or adjustment to nodes based on their order in the retrieval lists (e.g., node matches 336 or node matches 338). When combining scores from multiple retrieval methods, conservative fusion 310 can factor in how highly a node appears in each list, boosting the overall fused score for nodes that rank near the top. In some embodiments, the overlap status can be used in the fused score by identifying nodes that appear in the results of multiple retrieval methods, such as in both node matches 336 and node matches 338. Nodes with overlap, meaning they are retrieved by more than one method, can be assigned a boosted fused score, reflecting their consensus relevance. This approach increases confidence in the selection by prioritizing candidates that are recognized as relevant across different retrieval strategies.

Conservative fusion 310 may rank the nodes using the composite/fused scores to produce a top-K number of nodes as node matches 340, or a set of nodes that exceed a threshold score as node matches 340. In one example, conservative fusion 310 may output node matches 340 as follows:

Example: Conservative Fusion
node ID, fused score
501234: 2.4702 + 1.5 = 3.9702,
502156: 2.4036 + 1.0 = 3.4036,
503789: 2.3673 + 1.0 = 3.3673,
509876: 0.6,
504123: 2.2962,
.... ...

Optionally, initial node retrieval 202 implements LLM filtering 312 as an LLM-based reranking stage to refine the top candidates, e.g., node matches 340. Given serialized node descriptions of node matches 340 and query 140, a pre-trained transformer-based neural model or an LLM assesses the contextual relevance of each node while capturing latent associations beyond lexical or embedding signals. LLM filtering 312 can input query 140 and a serialized description of node matches 340 or the one or more nodes (e.g., node matches 338) and the one or more further nodes (e.g., node matches 336) into a further transformer-based neural network model to obtain the one or more initial nodes (e.g., one or more initial nodes 220).

In some embodiments, LLM filtering 312 refines the list of candidate nodes (e.g., node matches 340, or a combined set having node matches 338 and node matches 336) by inputting their serialized descriptions and query 140 into a large language model, which evaluates contextual relevance beyond basic retrieval scores. LLM filtering 312 can consider semantic relationships, latent associations, and query intent to produce a revised list of candidate nodes, with redundant or weakly relevant nodes demoted or removed from the revised list and potentially re-ranked nodes. LLM filtering 312 leverages the LLM's deep understanding of language and context to improve the precision of the final selection of one or more initial nodes 220. LLM filtering 312 can interpret nuanced relationships and intent of query 140, ensuring that the most contextually appropriate nodes are passed on for graph construction and reasoning.

In one example, LLM filtering 312 may output the following results:

Example: LLM filtering
APOE: Apolipoprotein E gene, major risk factor for Alzheimer's disease
Alzheimer disease: Progressive neurodegenerative disorder
Donepezil: Acetylcholinesterase inhibitor for Alzheimer's treatment
APP: Amyloid precursor protein gene
...

One or more hyperparameters 380 and one or more example values for one or more hyperparameters 380 for tuning the behavior of initial node retrieval 202 can include one or more of:

| | |
|---|---|
| • | VECTOR_SEARCH_TOP_K = 5 # Top-K nodes selected in vector similarity search 308 |
| | (in some cases, Top-K can be expressed as a percentage or proportion) |
| • | VECTOR_SEARCH_SCORE_THRESHOLD = 95% of the highest score # Threshold |
| | score used in vector similarity search 308 (in some cases, the threshold can be |
| | expressed as a numerical value or scalar) |
| • | SYMBOLIC_TEXT_TOP_K = 15 # Top-K nodes from symbolic text search 306 (in |
| | some cases, Top-K can be expressed as a percentage or proportion) |
| • | SYMBOLIC_SCORE_THRESHOLD = 88% of the highest score # Threshold score used |
| | in symbolic text search 306 (in some cases, the threshold can be expressed as a |
| | numerical value or scalar) |
| • | FUSION_FETCH_K = 15 # Number of candidates after conservative fusion 310 (in |
| | some cases, the number of candidates to use can be expressed as a percentage or |
| | proportion) |
| • | FUSION_SCORE_THRESHOLD = 30% of the highest fused score # Threshold score |
| | used in conservative fusion 310 (in some cases, the threshold can be expressed as a |
| | numerical value or scalar) |
| • | LLM_FETCH_K = 15 # Number of candidates after LLM filtering 312 (in some cases, |
| | the number of candidates to use can be expressed as a percentage or proportion) |

This multi-stage design yields an initial node set, e.g., node matches 340 or one or more initial nodes 220, that is semantically aligned with query 140, robust to lexical variation, and well-suited for downstream subgraph construction. Initial node retrieval 202 can be task-agnostic and easily generalizable across domains, enabling effective grounding in both open-domain and specialized RAG systems.

### Adaptive Subgraph Construction

FIG. 4 illustrates operations performed in adaptive subgraph construction 204, according to some embodiments of the disclosure. Given one or more initial nodes 220 obtained by initial node retrieval 202 of FIGS. 2-3, adaptive subgraph construction 204 constructs a local subgraph tailored to the input query (e.g., query 140 of FIGS. 1-3). Adaptive subgraph construction 204 constructs subgraph 230 based on the one or more initial nodes 220.

To support queries of varying complexity, adaptive subgraph construction 204 can be governed by a configuration-driven policy that includes one or more alternative expansion strategies. Adaptive subgraph construction 204 involves run expansion strategy 402 according to a specified policy. In run expansion strategy 402, adaptive subgraph construction 204 applies an expansion strategy to construct the subgraph (e.g., subgraph 230) based on the one or more initial nodes 220 and knowledge graph 104. For instance, when the retrieval configuration specifies a 2path policy, run expansion strategy 402 can attempt to discover both direct and two-hop relational paths among the seed entities (e.g., one or more initial nodes 220). 2path policy refers to a graph expansion strategy where, starting from the initial set of nodes (e.g., one or more initial nodes 220), adaptive subgraph construction 204 searches for all nodes that are reachable within two relational hops in the knowledge graph (e.g., knowledge graph 104 of FIG. 1). The expansion policy enables finding nodes directly connected to the seeds (1-hop), and also those connected via an intermediate node (2-hop), enabling richer discovery of relevant entities and relationships that may not be immediately adjacent. A Cypher-based expansion procedure, which enumerates pairwise connections between seeds (e.g., two initial nodes) and materializes intermediate nodes when available. Cypher-based expansion uses the Cypher query language to formulate Cypher queries that enumerate all paths of length one and two between the initial nodes and other nodes in the graph. By executing these queries, adaptive subgraph construction 204 efficiently generates subgraph 230 that includes both direct and indirect connections. The resulting subgraph, e.g., subgraph 230, can reveal richer semantic information, supporting more comprehensive retrieval and reasoning for downstream tasks. In the biological sciences domain, constructing a subgraph using a 2path expansion policy can better reveal the biological mechanisms, such as gene-protein-disease cascades or drug-enzyme-symptom pathways, thereby providing a broader evidential basis for downstream reasoning.

However, complex multi-hop queries may be computationally expensive or occasionally unstable. To mitigate this, adaptive subgraph construction 204 incorporates an adaptive fallback mechanism. If the initial expansion strategy (e.g., a 2path query) exceeds a predefined runtime threshold (e.g., 10 seconds) or yields an empty result set, illustrated by check 404, adaptive subgraph construction 204 degrades to an alternative expansion strategy (e.g., a more lightweight 1hop expansion strategy). The fallback mechanism ensures that every query, irrespective of its complexity, produces a valid subgraph (e.g., subgraph 230) while preserving responsiveness under constrained conditions. 1hop refers to a graph traversal strategy where, starting from a set of initial nodes (e.g., one or more initial nodes 220), the expansion strategy identifies all nodes that are directly connected to those seeds by a single edge in the knowledge graph (e.g., knowledge graph 104). This approach captures immediate relationships, such as direct associations, links, or references, between entities, enabling efficient construction of a local subgraph (e.g., subgraph 230) that reflects the most immediate context of the query. 1hop expansion is computationally lightweight and is often used as a fallback or baseline method when broader multi-hop exploration becomes unstable or is too resource-intensive. Empirical statistics show that only a small fraction of queries trigger such fallback, and the alternative expansions can still preserve core associations.

In some embodiments, check 404 checks whether one or more fallback conditions are met. The one or more fallback conditions can include one or more of: a timeout condition, and an empty result set being generated. For example, check 404 can check if one or more fallback conditions, e.g., TIMEOUT | | EMPTY SET?, is true or false. If true, adaptive subgraph construction 204 proceeds to run alternative expansion strategy 406. If false, adaptive subgraph construction 204 proceeds to output subgraph 230. Based on one or more fallback conditions being met, Run alternative expansion strategy 406 can apply an alternative expansion strategy to construct the subgraph based on one or more initial nodes 220 and knowledge graph 104.

In some embodiments, one or more further checks and one or more further alternative expansion strategies can be run until a valid subgraph can be produced.

In some embodiments, to enhance the representational quality of the constructed graph, each edge can be enriched with dense embeddings that capture relational semantics. Depending on the configuration, these embeddings may encode simple relation types or triplets of the form (source type, relation, target type). Such embeddings support one or more subsequent modules that integrate structural and semantic information in a unified representation space. In addition, one or more quality control metrics, such as subgraph size, seed node coverage, and type distribution, can be computed to monitor subgraph construction outcomes and guide dynamic adjustments.

One or more hyperparameters 480 and one or more example values for one or more hyperparameters 480 for tuning the behavior of adaptive subgraph construction 204 can include one or more of:

| | |
|---|---|
| • | MAX_HOPS = 2 # Maximum hops for subgraph expansion policy |
| | applied in run expansion strategy 402 |
| • | TIMEOUT_THRESHOLD = 10 # Threshold before fallback to |
| | simpler expansion used in check 404, e.g., defined in seconds |

Through this adaptive design, adaptive subgraph construction 204 achieves a balance between expressivity and robustness. Adaptive subgraph construction 204 can flexibly exploit complex relational structures when available. Adaptive subgraph construction 204 can degrade gracefully to ensure coverage and stability. This adaptability is particularly beneficial in biomedical domains or other complex domains, where queries often involve heterogeneous entities and incomplete graph coverage, making it essential to capture as much relevant evidence as possible without compromising efficiency.

Subgraph Pruning with Learnable Prize Parameters

FIG. 5 illustrates operations performed in subgraph pruning 206 with learnable parameters, according to some embodiments of the disclosure. After constructing subgraph 230, subgraph pruning 206 prunes subgraph 230 based on the PCST formulation and produces pruned subgraph 106. The goal of subgraph pruning 206 is to preserve a compact yet informative substructure in pruned subgraph 106 that maximizes task relevance while suppressing noisy or redundant branches.

The PCST formulation is an optimization approach used to select a compact, connected subgraph (e.g., pruned subgraph 106) from a larger graph (e.g., subgraph 230), balancing the inclusion of valuable nodes against the cost of connecting them. Each node is assigned a “prize” and each edge has an associated connection cost. Leveraging query-conditioned prize assignment parameters, the prizes and/or costs can reflect their relevance to query 140. Leveraging learnable prize assignment parameters, the prizes and/or costs can be further tailored to the specific context, domain, or knowledge graph 104. The objective of the PCST formulation is to maximize the total prize collected from selected nodes minus the total cost of the edges to connect them, resulting in pruned subgraph 106 that is both informative and efficient. In knowledge graph-based retrieval systems, the PCST formulation enables adaptive pruning by dynamically adjusting node prizes and edge costs based on query semantics, ensuring that pruned subgraph 106 retains the most critical evidence for downstream reasoning while minimizing redundancy and computational overhead. Moreover, the node prizes and edge costs are adjusted based on prize assignment parameters that are learned from knowledge graph 104 using contrastive learning, ensuring that the pruning process takes the context and knowledge domain into account.

In some embodiments, subgraph pruning 206 determines one or more prize parameters (e.g., one or more prize assignment parameters 562) based on query 140. Subgraph pruning 206 can calculate one or more node prizes and one or more edge prizes for the subgraph based on the one or more prize parameters (e.g., one or more prize assignment parameters 562). For example, calculate node prizes 504 can calculate one or more node prizes based on one or more prize assignment parameters 562. Calculate edge prizes 506 can calculate one or more edge prizes based on one or more prize assignment parameters 562. Subgraph pruning 206 can prune subgraph 230 (or PCST base graph 560) based on the one or more node prizes and the one or more edge prizes to generate pruned subgraph 106. For example, prune nodes 508 can determine a smaller subgraph that maximizes a net reward.

In some embodiments, subgraph pruning 206 includes transform to PCST topology 584. In transform to PCST topology 584, nodes and edges of subgraph 230 are mapped to continuous indices and associated with prize and cost values. Subgraph 230 is transformed into PCST base graph 560. With PCST base graph 560, the pruning task of subgraph pruning 206 is then framed as selecting a connected subgraph that maximizes the net reward (e.g., sum of node and edge prizes minus connection costs).

Unlike traditional PCST implementations that rely on hand-crafted heuristics for determining the prize assignment parameters, subgraph pruning 206 adopts a learnable prize assignment strategy. Query 140 is embedded and optionally combined with lightweight textual features or entities (e.g., presence of biomedical keywords such as “gene,” “drug,” or “disease”) to produce a feature vector that conditions a model (e.g., a small parametric model, shown as model 534). Phrased differently, query 140 is used to determine the prize parameters used in the PCST formulation. Subgraph pruning 206 includes determine prize assignment parameter(s) 502 that receives query 140 and outputs one or more prize assignment parameters 562. Model 534 predicts one or more latent parameters (e.g., one or more prize assignment parameters 562) governing the PCST reward landscape, including one or more of: base prize magnitude, exponential decay rate across candidate ranks, edge reward multiplier, and a query-specific boosting factor. The resulting prize allocation is thus adaptive to both the structural properties of subgraph 230 and the semantic profile of query 140.

In some embodiments, determine prize assignment parameter(s) 502 inputs the query to model 534 trained on one or more initial nodes 220 and/or knowledge graph 104 using contrastive learning to obtain the one or more parameters (e.g., one or more prize assignment parameters 562). In some embodiments, one or more entities can be extracted from the query (as illustrated in entity extraction 302 of FIG. 3). Determine prize assignment parameter(s) 502 inputs one or more of query 140 and the one or more entities to model 534, whose model parameters are trained on one or more initial nodes 220 and/or knowledge graph 104 using contrastive learning to obtain the one or more parameters (e.g., one or more prize assignment parameters 562). One or more prize assignment parameters 562 can include one or more of: a base prize magnitude, an exponential decay rate, an edge reward multiplier, and a query-specific boosting factor.

Model 534 can be trained using the following contrastive learning loss function:

$$ℒ = {\sum }_{i ∈ V} log \frac{{\sum }_{j ∈ P ( i )} exp ( \frac{{h}_{i}^{T} {h}_{j}}{τ} )}{{\sum }_{j ∈ P ( i )} exp ( \frac{{h}_{i}^{T} {h}_{j}}{τ} ) + {\sum }_{k ∈ N ( i )} exp ( \frac{{h}_{i}^{T} {h}_{k}}{τ} )}$$

V represents a set of nodes in subgraph 230 (or PCST base graph 560). hᵢ is a feature vector of node i. P(i) represents a positive set, having all ground-truth nodes related to node i, which can be obtained from knowledge graph 104. N(i) represents a negative set, sampled randomly from the node pool (e.g., from knowledge graph 104), with an equal size to P(i). τ is a temperature hyperparameter, e.g., set at 0.1.

The contrastive learning loss function helps model 534 distinguish between relevant (positive) and irrelevant (negative) nodes in a generated subgraph. For each node i in the set V, model 534 compares the feature vector hᵢ of node i with those of nodes in the positive set P(i) (ground-truth related nodes) and the negative set N(i) (randomly sampled unrelated nodes). The numerator computes the similarity for the positive examples and the denominator sums the similarities to positive and negative nodes. The similarity is calculated, e.g., by computing dot products seen as

$${h}_{i}^{T} {h}_{j}$$

for the positive comparison and

$${h}_{i}^{T} {h}_{k}$$

for the negative comparison and scaling the dot products by temperature τ. The loss encourages model 534 to assign higher similarity scores to positive pairs than to negative pairs, making the embeddings of related nodes closer together and unrelated nodes further apart in the feature space. The temperature parameter t controls the sharpness of the similarity distribution, with lower values making model 534 focus more on the most similar pairs.

This contrastive learning approach is semi-supervised. Model 534 is trained through a combination of limited labeled data (the positive set, which has ground-truth related nodes determined for query 140, e.g., one or more initial nodes 220) and a larger pool of unlabeled data (the negative set, sampled randomly from the node pool, e.g., from knowledge graph 104). Model 534 learns to distinguish relevant nodes from irrelevant ones by maximizing similarity within the positive pairs and minimizing it for negative pairs, even though only the positive pairs are explicitly labeled. The negative samples provide additional structure and diversity, helping model 534 generalize beyond the annotated ground-truth. This setup leverages both supervision from labeled relationships and unsupervised learning from the broader graph, making it semi-supervised.

Model 534 can be trained offline during a training phase where model 534 may be exposed to labeled positive nodes (e.g., one or more initial nodes 220) and sampled negative nodes from knowledge graph 104. One or more model parameters of model 534 are updated using the contrastive loss function to maximize similarity for positive nodes and minimize similarity for negative pairs. The one or more model parameters can be used by determine prize assignment parameter(s) 502. In some implementations, the one or more model parameters can be updated on-the-fly as one or more initial nodes 220 are determined for query 140 to account for drift in the types of queries being received.

Base prize magnitude is the initial value assigned to each node in PCST base graph 560, reflecting its fundamental relevance or importance before any adjustments. A higher base prize means the node is considered more valuable for inclusion in the subgraph. Exponential decay rate controls how quickly the prize assigned to a node decreases as its distance (number of hops or steps) from an initial node increases. A higher decay rate causes prizes to diminish more rapidly for nodes that are further away, favoring closer connections. Edge reward multiplier is a factor that adjusts the value contributed by edges (connections) between nodes, rewarding or penalizing certain types of relationships. Increasing the multiplier boosts the incentive to include well-connected nodes or specific edge types in the subgraph. Query-specific boosting factor can be applied based on the content or focus of query 140, amplifying the prize for nodes or edges that are particularly relevant to the intent of query 140. The factor enables tailoring subgraph selection to the unique context of query 140, and governs how much weight to give to the context of query 140 when pruning the subgraph.

Calculate node prizes 504 can compute, for each node in PCST base graph 560:

$$node\_prize = base\_prize * exp ( decay\_rate * distance ) * query\_boost$$

For each node, the base prize magnitude (“base_prize”) is assigned as its initial value. This prize is then multiplied by an exponential decay factor, which reduces the prize based on the node's distance (number of hops, or “distance”) from the initial nodes (e.g., one or more initial nodes 220). The exponential decay factor is dependent on an exponential decay rate (“decay_rate”). Specifically, the prize is scaled by exp (-decay_rate*distance). The node prize may also be multiplied by a query-specific boosting factor (e.g., scaled by “query_boost”), which increases the prize for nodes that are particularly relevant to the content or intent of query 140.

Calculate edge prizes 506 can compute, for each edge in PCST base graph 560:

$$edge\_prize = base\_edge \_value * edge\_reward \_multiplier * query\_boost$$

For each edge, the edge reward multiplier (“edge_reward_multiplier”) is applied to the base edge value (which may reflect the type or strength of the relationship). The edge prize can be further scaled by the query-specific boosting factor (e.g., scaled by “query_boost”) based on the relevance of the edge to query 140.

Overall, the learnable PCST formulation implemented in subgraph pruning 206 provides a principled and adaptive mechanism for subgraph pruning in retrieval-augmented generation pipelines. Subgraph pruning 206 achieves a favorable trade-off between recall and interpretability, ensuring that downstream language models operate over a structured context that is both semantically focused and contextually meaningful.

In some embodiments, reinforcement learning (RL) can be used as an alternative or complementary mechanism for determining one or more prize parameters used in the PCST-based subgraph pruning process. Instead of relying solely on contrastive learning to distinguish positive and negative node relationships, an RL-based approach models subgraph pruning as a sequential decision-making problem in which an agent learns pruning strategies that directly optimize end-to-end system performance. The RL agent receives as input the query (e.g., query 140), the initial or partially constructed subgraph (e.g., subgraph 230), and optionally intermediate graph representations generated by upstream retrieval stages. Based on this state information, the agent selects pruning actions, such as retaining or removing specific nodes or edges, or adjusting prize-related parameters, that aim to maximize a task-specific reward signal.

In some embodiments, the reward function is designed to reflect downstream quality metrics associated with the retrieval-augmented generation pipeline. For example, the reward may incorporate the accuracy, groundedness, or relevance of the evidence-grounded answer produced by the GNN-LLM inference process, as well as computational efficiency metrics such as subgraph size, latency, or resource utilization. By tying the reward to end-to-end system outputs, the RL agent can learn pruning behaviors (e.g., by updating parameters of model 534) that are directly aligned with the ultimate objective of producing high-quality, contextually faithful answers, rather than relying on static heuristics or local similarity constraints. Using the RL agent to determine one or more optimal prize parameters can enable dynamic adaptation of pruning strategies across queries and domains, especially in scenarios where the relationship between graph structure and answer quality is highly nonlinear or context dependent.

In some embodiments, the RL framework may use a policy-gradient model, Q-learning variant, or actor-critic architecture to learn a policy that maps graph-state representations to pruning decisions. The policy may be initialized using one or more prize assignment parameters obtained from contrastive learning or a suitable semi-supervised or supervised pre-training method, and subsequently fine-tuned through RL to incorporate long-range dependencies and multi-hop reasoning effects that cannot be easily captured through contrastive objectives alone. This hybrid training approach can stabilize RL optimization while preserving the semantic richness of the initial representations encoded in the prize assignment parameters.

In some embodiments, the RL-based pruning process may operate in conjunction with the PCST formulation. For example, the RL agent may predict the one or more prize assignment parameters (e.g., base prize magnitude, decay rate, edge reward multiplier, and query-specific boosting factor) that are then used by the PCST solver to generate a pruned subgraph. Alternatively, the RL agent may directly select nodes or edges for retention or removal without relying on explicit PCST optimization. These variations provide flexibility in integrating RL with existing graph-theoretic pruning techniques and allow organizations to balance interpretability, computational requirements, and performance considerations.

By incorporating reinforcement learning, subgraph pruning 206 can adaptively refine pruning strategies through continuous feedback, enabling the retrieval-augmented generation pipeline to evolve over time as query distributions, knowledge graphs, or downstream task requirements change. RL-based pruning provides a principled mechanism for optimizing complex, multi-stage graph reasoning behaviors in a manner that is sensitive to both structural features of the knowledge graph (e.g., knowledge graph 104) and semantic attributes of the query (e.g., query 140).

### GNN-LLM Joint Inference

FIG. 6 illustrates operations performed in GNN-LLM joint inference system 120, according to some embodiments of the disclosure. GNN-LLM joint inference system 120 integrates GNNs with LLMs to produce evidence-grounded answer 108. Query 140 and pruned subgraph 106 are provided as inputs to a generative neural network model, e.g., LLM 610, to generate evidence-grounded answer 108 to query 140.

GNN-LLM joint inference system 120 can include GNN encoding 602, which encodes pruned subgraph 106 using a graph attention network. Pruned subgraph 106, which includes relevant entities and relations, is encoded into high-dimensional node embeddings. Each node is associated with semantic vectors derived from knowledge bases, which are then propagated through a GNN, e.g., a multilayer graph attention network (GAT), to capture higher-order dependencies across the subgraph. This graph encoder or GNN in GNN encoding 602 outputs structured representations that are aligned with the dimensionality of the target LLM embedding space.

GNN-LLM joint inference system 120 further includes projection 604 to project graph-level embeddings generated in GNN encoding 602 into the language model space. The encoded graph features generated in GNN encoding 602 are projected through one or more (lightweight) neural network layers, e.g., a multilayer perceptron model, and aggregated into graph-level embeddings to enable cross-modal reasoning.

GNN-LLM joint inference system 120 further includes LLM tokenization and generate embeddings 606 to convert query 140 into query features.

GNN-LLM joint inference system 120 further includes graph-text fusion 608 to fuse the encoded graph features from projection 604 and query features from LLM tokenization and generate embeddings 606. The fused features can form an enriched context for answer generation.

GNN-LLM joint inference system 120 further includes LLM 610, which receives the fused features to generate evidence-grounded answer 108. LLM 610 can support both standard and optional chain-of-thought reasoning. In some embodiments, LLM 610 can support question answering under either a standard inference mode or a chain-of-thought (CoT) prompting regime. The latter encourages explicit reasoning steps, guiding the model to articulate intermediate connections, e.g., such as gene-protein-disease pathways and drug-target mechanisms in the biomedical domain.

GNN-LLM joint inference system 120 ensures that downstream generation is grounded in structured graph evidence while retaining the expressive capacity of LLM 610. By coupling structural encoding with language-based reasoning, GNN-LLM joint inference system 120 is able to produce answers that are both semantically faithful to the domain of the knowledge graphs and logically coherent in natural language, thereby enhancing accuracy, interpretability, and plausibility in retrieval-augmented inference.

One or more hyperparameters 680 and one or more example values for one or more hyperparameters 680 for tuning the behavior of GNN-LLM joint inference system 120 can include one or more of:

| | |
|---|---|
| • | TEMPERATURE = 0.0 # LLM generation temperature |
| | (0=deterministic, 1=random) |
| • | MAX_NEW_TOKENS = 1000 # Maximum tokens to generate |
| • | REPETITION_PENALTY = 1.1 # Penalty for repetitive text |

### Methods for Graph Control in a Knowledge Graph-Based RAG System

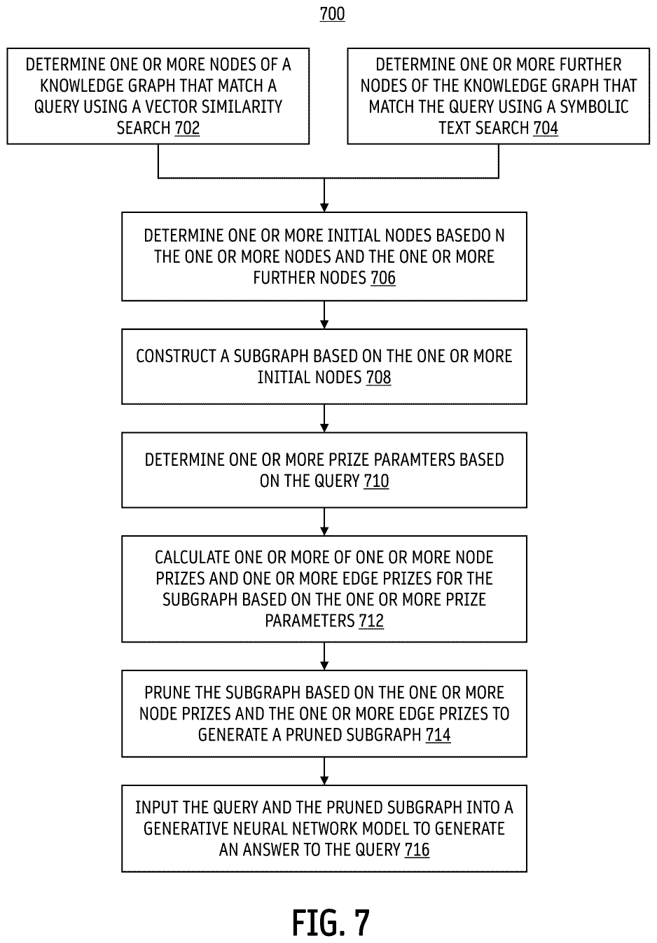

FIG. 7 depicts a flow diagram illustrating method 700 performing RAG, according to some embodiments of the disclosure. Method 700 can be performed by one or more components illustrated in FIGS. 1-6.

In 702, one or more nodes of a knowledge graph that match a query are determined using a vector similarity search.

In 704, one or more further nodes of the knowledge graph that match the query are determined using a symbolic text search.

In 706, one or more initial nodes are determined based on the one or more nodes and the one or more further nodes.

In 708, a subgraph is constructed based on the one or more initial nodes.

In 710, one or more prize parameters are determined based on the query.

In 712, one or more node prizes and one or more edge prizes for the subgraph are calculated based on the one or more prize parameters.

In 714, the subgraph is pruned based on the one or more node prizes and the one or more edge prizes to generate a pruned subgraph.

In 716, the query and the pruned subgraph are input into a generative neural network model to generate an answer to the query.

### Exemplary Computing Device

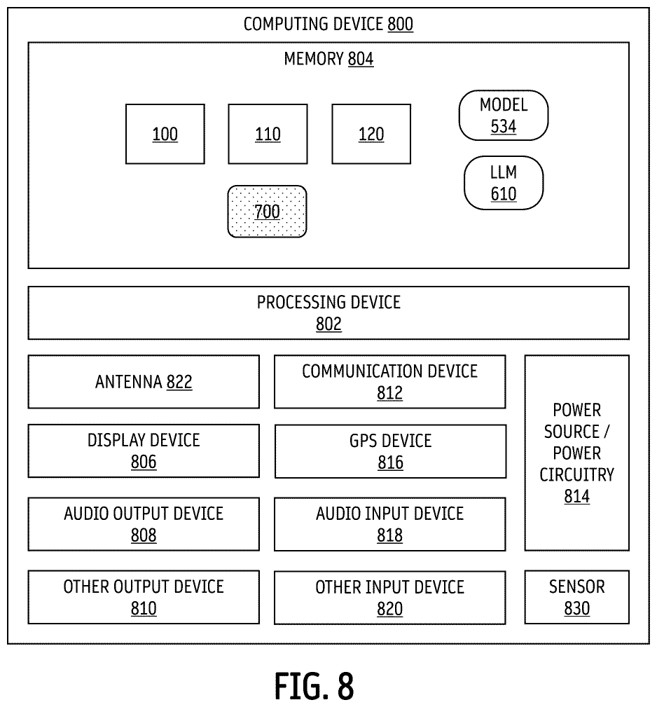

FIG. 8 is a block diagram of an apparatus or a system, e.g., an exemplary computing device 800, according to some embodiments of the disclosure. One or more computing devices 800 may be used to implement the functionalities described with the FIGS. and herein. A number of components illustrated in FIG. 8 can be included in computing device 800, but any one or more of these components may be omitted or duplicated, as suitable for the application. In some embodiments, some or all of the components included in computing device 800 may be attached to one or more motherboards. In some embodiments, some or all of these components are fabricated onto a single system on a chip (SoC) die. Additionally, in various embodiments, computing device 800 may not include one or more of the components illustrated in FIG. 8, and computing device 800 may include interface circuitry for coupling to the one or more components. For example, computing device 800 may not include display device 806, and may include display device interface circuitry (e.g., a connector and driver circuitry) to which a display device 806 may be coupled. In another set of examples, computing device 800 may not include audio input device 818 or an audio output device 808 and may include audio input or output device interface circuitry (e.g., connectors and supporting circuitry) to which an audio input device 818 or audio output device 808 may be coupled.

Computing device 800 may include processing device 802 (e.g., one or more processing devices, one or more of the same type of processing device, one or more of different types of processing devices). Processing device 802 may include electronic circuitry that processes electronic data from data storage elements (e.g., registers, memory, resistors, capacitors, quantum bit cells) to transform that electronic data into other electronic data that may be stored in registers and/or memory. Examples of processing device 802 may include a CPU, a GPU, a quantum processor, a machine learning processor, an artificial intelligence processor, a neural network processor, a neural processing unit (NPU), an artificial intelligence accelerator, an application-specific integrated circuit (ASIC), an analog signal processor, an analog computer, a microprocessor, a digital signal processor, a field-programmable gate array (FPGA), a tensor processing unit (TPU), a data processing unit (DPU), etc.

Computing device 800 may include a memory 804, which may itself include one or more memory devices such as volatile memory (e.g., DRAM), nonvolatile memory (e.g., read-only memory (ROM)), high-bandwidth memory (HBM), flash memory, solid-state memory, and/or a hard drive. Memory 804 includes one or more non-transitory computer-readable storage media. In some embodiments, memory 804 may include memory that shares a die with the processing device 802. Memory 804 may store machine-readable instructions, and processing device 802 may execute the machine-readable instructions.

In some embodiments, memory 804 includes one or more non-transitory computer-readable media storing instructions executable to perform operations described with the FIGS. and herein, such as the methods and operations illustrated in the FIGS. In some embodiments, memory 804 includes one or more non-transitory computer-readable media storing instructions executable to perform one or more operations illustrated in FIGS. 1-6, such as one or more operations illustrated in query-aware multi-stage graph control system 110 and one or more operations illustrated in GNN-LLM joint inference system 120. In some embodiments, memory 804 includes one or more non-transitory computer-readable media storing instructions executable to perform one or more operations of method 700 of FIG. 7. Memory 804 may store instructions that encode one or more exemplary parts, such as one or more components of knowledge graph-based RAG system 100 as illustrated and described herein. The instructions stored in the one or more non-transitory computer-readable media may be executed by processing device 802.

In some embodiments, memory 804 may store data, e.g., data structures, binary data, bits, metadata, files, blobs, etc., as described with the FIGS. and herein. For example, memory 804 may include one or more of: query 140, knowledge graph 104, pruned subgraph 106, evidence-grounded answer 108, one or more initial nodes 220, subgraph 230, one or more hyperparameters 280, one or more entities 330, vector 332, node matches 336, node matches 338, node matches 340, one or more hyperparameters 380, one or more hyperparameters 480, PCST base graph 560, one or more prize assignment parameters 562, node prizes, edge prizes, and one or more hyperparameters 680. Memory 804 may store data received and/or generated by parts such as one or more components of knowledge graph-based RAG system 100. Memory 804 may store data received and/or generated by operations illustrated in FIGS. 1-6.

In some embodiments, memory 804 may store one or more machine learning models (and/or parts thereof). Memory 804 may store training data for training (or trained) one or more machine learning models, such as one or more of model 534, LLM 610, a transformer-based neural network, a multilayer perceptron model, a neural network model, and other models and/or encoders mentioned herein. Memory 804 may store instructions that perform operations associated with training the one or more machine learning models. Memory 804 may store input data, output data, intermediate outputs, intermediate inputs of one or more machine learning models. Memory 804 may store instructions to perform one or more operations of the one or more machine learning models. Memory 804 may store one or more parameters used by the one or more machine learning models. Memory 804 may store information that encodes how processing units of the machine learning model are connected with each other.

In some embodiments, computing device 800 may include communication device 812 (e.g., one or more communication devices). For example, the communication device 812 may be configured for managing wired and/or wireless communications for the transfer of data to and from computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols. Communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long Term Evolution (LTE) network. Communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). Communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. Communication device 812 may operate in accordance with other wireless protocols in other embodiments. Computing device 800 may include an antenna 822 to facilitate wireless communications and/or to receive other wireless communications (such as radio frequency transmissions). Computing device 800 may include receiver circuits and/or transmitter circuits. In some embodiments, communication device 812 may manage wired communications, such as electrical, optical, or any other suitable communication protocols (e.g., the Ethernet). As noted above, communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

Computing device 800 may include power source/power circuitry 814. The power source/power circuitry 814 may include one or more energy storage devices (e.g., batteries or capacitors) and/or circuitry for coupling components of computing device 800 to an energy source separate from computing device 800 (e.g., DC power, AC power, etc.).

Computing device 800 may include a display device 806 (or corresponding interface circuitry, as discussed above). Display device 806 may include any visual indicators, such as a heads-up display, a computer monitor, a projector, a touchscreen display, a liquid crystal display (LCD), a light-emitting diode display, or a flat panel display, for example.

Computing device 800 may include an audio output device 808 (or corresponding interface circuitry, as discussed above). The audio output device 808 may include any device that generates an audible indicator, such as speakers, headsets, or earbuds, for example.

Computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

Computing device 800 may include GPS device 816 (or corresponding interface circuitry, as discussed above). GPS device 816 may be in communication with a satellite-based system and may receive a location of computing device 800, as known in the art.

Computing device 800 may include sensor 830 (or one or more sensors). Computing device 800 may include corresponding interface circuitry, as discussed above). Sensor 830 may sense one or more physical phenomena and translate the one or more physical phenomena into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

Computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 800 may have any desired form factor, such as a handheld or mobile computer system (e.g., a cell phone, a smart phone, a mobile Internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, computing device 800 may be any other electronic device that processes data.

### Select Examples

Example 1 provides one or more non-transitory computer-readable media including instructions, that when executed by one or more processors, cause the one or more processors to perform operations for knowledge graph-based retrieval-augmented generation, the operations including determining, using a vector similarity search, one or more nodes of a knowledge graph that match a query; determining, using a symbolic text search, one or more further nodes of the knowledge graph that match the query; determining one or more initial nodes based on the one or more nodes and the one or more further nodes; constructing a subgraph based on the one or more initial nodes; determining one or more prize parameters based on the query; calculating one or more node prizes and one or more edge prizes for the subgraph based on the one or more prize parameters; pruning the subgraph based on the one or more node prizes and the one or more edge prizes to generate a pruned subgraph; and inputting the query and the pruned subgraph into a generative neural network model to generate an answer to the query.

Example 2 provides the one or more non-transitory computer-readable media of example 1, where determining the one or more further nodes of the knowledge graph that match the query includes extracting one or more entities from the query; inputting one or more of the query and the one or more entities into a transformer-based neural network to obtain one or more attention scores corresponding to the one or more entities; and calculating one or more matching scores for one or more nodes of the knowledge graph based on the one or more entities and the one or more attention scores corresponding to the one or more entities.

Example 3 provides the one or more non-transitory computer-readable media of example 1 or 2, where determining the one or more initial nodes based on the one or more nodes and the one or more further nodes includes calculating a fused score of an initial node of the one or more initial nodes based on a minimum of a vector similarity search score corresponding to the initial node and a symbolic text search score corresponding to the initial node.

Example 4 provides the one or more non-transitory computer-readable media of example 3, where the vector similarity search score is weighted according to a first weight and the symbolic text search score is weighted according to a second weight, the first weight and the second weight being adjustable to prioritize precision or recall.

Example 5 provides the one or more non-transitory computer-readable media of example 3 or 4, where calculating the fused score of the initial node further based on one or more of: a rank position of the initial node, and an overlap status of the initial node.

Example 6 provides the one or more non-transitory computer-readable media of any one of examples 1-5, where determining the one or more initial nodes based on the one or more nodes and the one or more further nodes includes inputting the query and a description of the one or more nodes and the one or more further nodes into a further transformer-based neural network model to obtain the one or more initial nodes.

Example 7 provides the one or more non-transitory computer-readable media of any one of examples 1-6, where constructing the subgraph based on the one or more initial nodes includes applying an expansion strategy to construct the subgraph based on the one or more initial nodes and the knowledge graph; and based on one or more fallback conditions being met, applying an alternative expansion strategy to construct the subgraph based on the one or more initial nodes and the knowledge graph, the one or more fallback conditions including one or more of: a timeout condition, and an empty result set being generated.

Example 8 provides the one or more non-transitory computer-readable media of any one of examples 1-7, where determining the one or more prize parameters based on the query includes inputting the query into a model trained on the one or more initial nodes and the knowledge graph using machine learning to obtain the one or more prize parameters.

Example 9 provides the one or more non-transitory computer-readable media of any one of examples 1-8, where determining the one or more prize parameters based on the query includes extracting one or more entities from the query; and inputting one or more of the query and the one or more entities into a model whose model parameters are trained on the one or more initial nodes and the knowledge graph using machine learning to obtain the one or more prize parameters.

Example 10 provides the one or more non-transitory computer-readable media of any one of examples 1-9, where the one or more prize parameters include one or more of a base prize magnitude, an exponential decay rate, an edge reward multiplier, and a query-specific boosting factor.

Example 11 provides a knowledge graph-based retrieval-augmented generation system, including one or more processors; and one or more memories to store a knowledge graph and instructions, where the instructions cause the one or more processors to perform operations including determining, using a vector similarity search, one or more nodes of the knowledge graph that match a query; determining, using a symbolic text search, one or more further nodes of the knowledge graph that match the query; determining one or more initial nodes based on the one or more nodes and the one or more further nodes; constructing a subgraph based on the one or more initial nodes; determining one or more prize parameters based on the query; calculating one or more node prizes and one or more edge prizes for the subgraph based on the one or more prize parameters; pruning the subgraph based on the one or more node prizes and the one or more edge prizes to generate a pruned subgraph; and inputting the query and the pruned subgraph into a generative neural network model to generate an answer to the query.

Example 12 provides the knowledge graph-based retrieval-augmented generation system of example 11, where determining the one or more further nodes of the knowledge graph that match the query includes extracting one or more entities from the query; inputting one or more of the query and the one or more entities into a transformer-based neural network to obtain one or more attention scores corresponding to the one or more entities; and calculating one or more matching scores for one or more nodes of the knowledge graph based on the one or more entities and the one or more attention scores corresponding to the one or more entities.

Example 13 provides the knowledge graph-based retrieval-augmented generation system of example 11 or 12, where determining the one or more initial nodes based on the one or more nodes and the one or more further nodes includes calculating a fused score of an initial node of the one or more initial nodes based on a minimum of a vector similarity search score corresponding to the initial node and a symbolic text search score corresponding to the initial node.

Example 14 provides the knowledge graph-based retrieval-augmented generation system of example 13, where the vector similarity search score is weighted according to a first weight and the symbolic text search score is weighted according to a second weight, the first weight and the second weight being adjustable to prioritize precision or recall.

Example 15 provides the knowledge graph-based retrieval-augmented generation system of example 13 or 14, where calculating the fused score of the initial node further based on one or more of: a rank position of the initial node, and an overlap status of the initial node.

Example 16 provides the knowledge graph-based retrieval-augmented generation system of any one of examples 11-15, where determining the one or more initial nodes based on the one or more nodes and the one or more further nodes includes inputting the query and a description of the one or more nodes and the one or more further nodes into a further transformer-based neural network model to obtain the one or more initial nodes.

Example 17 provides the knowledge graph-based retrieval-augmented generation system of any one of examples 11-16, where constructing the subgraph based on the one or more initial nodes includes applying an expansion strategy to construct the subgraph based on the one or more initial nodes and the knowledge graph; and based on one or more fallback conditions being met, applying an alternative expansion strategy to construct the subgraph based on the one or more initial nodes and the knowledge graph, the one or more fallback conditions including one or more of: a timeout condition, and an empty result set being generated.

Example 18 provides the knowledge graph-based retrieval-augmented generation system of any one of examples 11-17, where determining the one or more prize parameters based on the query includes inputting the query into a model trained on the one or more initial nodes and the knowledge graph using machine learning to obtain the one or more prize parameters.

Example 19 provides the knowledge graph-based retrieval-augmented generation system of any one of examples 11-18, where determining the one or more prize parameters based on the query includes extracting one or more entities from the query; and inputting one or more of the query and the one or more entities into a model whose model parameters are trained on the one or more initial nodes and the knowledge graph using machine learning to obtain the one or more prize parameters.

Example 20 provides the knowledge graph-based retrieval-augmented generation system of any one of examples 11-19, where the one or more prize parameters include one or more of a base prize magnitude, an exponential decay rate, an edge reward multiplier, and a query-specific boosting factor.

Example 21 provides a knowledge graph-based retrieval-augmented generation method, including determining, using a vector similarity search, one or more nodes of a knowledge graph that match a query; determining, using a symbolic text search, one or more further nodes of the knowledge graph that match the query; determining one or more initial nodes based on the one or more nodes and the one or more further nodes; constructing a subgraph based on the one or more initial nodes; determining one or more prize parameters based on the query; calculating one or more node prizes and one or more edge prizes for the subgraph based on the one or more prize parameters; pruning the subgraph based on the one or more node prizes and the one or more edge prizes to generate a pruned subgraph; and inputting the query and the pruned subgraph into a generative neural network model to generate an answer to the query.

Example 22 provides the knowledge graph-based retrieval-augmented generation method of example 21, where determining the one or more further nodes of the knowledge graph that match the query includes extracting one or more entities from the query; inputting one or more of the query and the one or more entities into a transformer-based neural network to obtain one or more attention scores corresponding to the one or more entities; and calculating one or more matching scores for one or more nodes of the knowledge graph based on the one or more entities and the one or more attention scores corresponding to the one or more entities.

Example 23 provides the knowledge graph-based retrieval-augmented generation method of example 21 or 22, where determining the one or more initial nodes based on the one or more nodes and the one or more further nodes includes calculating a fused score of an initial node of the one or more initial nodes based on a minimum of a vector similarity search score corresponding to the initial node and a symbolic text search score corresponding to the initial node.

Example 24 provides the knowledge graph-based retrieval-augmented generation method of example 23, where the vector similarity search score is weighted according to a first weight and the symbolic text search score is weighted according to a second weight, the first weight and the second weight being adjustable to prioritize precision or recall.

Example 25 provides the knowledge graph-based retrieval-augmented generation method of example 23 or 24, where calculating the fused score of the initial node further based on one or more of: a rank position of the initial node, and an overlap status of the initial node.

Example 26 provides the knowledge graph-based retrieval-augmented generation method of any one of examples 21-25, where determining the one or more initial nodes based on the one or more nodes and the one or more further nodes includes inputting the query and a description of the one or more nodes and the one or more further nodes into a further transformer-based neural network model to obtain the one or more initial nodes.

Example 27 provides the knowledge graph-based retrieval-augmented generation method of any one of examples 21-26, where constructing the subgraph based on the one or more initial nodes includes applying an expansion strategy to construct the subgraph based on the one or more initial nodes and the knowledge graph; and based on one or more fallback conditions being met, applying an alternative expansion strategy to construct the subgraph based on the one or more initial nodes and the knowledge graph, the one or more fallback conditions including one or more of: a timeout condition, and an empty result set being generated.

Example 28 provides the knowledge graph-based retrieval-augmented generation method of any one of examples 21-27, where determining the one or more prize parameters based on the query includes inputting the query into a model trained on the one or more initial nodes and the knowledge graph using machine learning to obtain the one or more prize parameters.

Example 29 provides the knowledge graph-based retrieval-augmented generation method of any one of examples 21-28, where determining the one or more prize parameters based on the query includes extracting one or more entities from the query; and inputting one or more of the query and the one or more entities into a model whose model parameters are trained on the one or more initial nodes and the knowledge graph using machine learning to obtain the one or more prize parameters.

Example 30 provides the knowledge graph-based retrieval-augmented generation method of any one of examples 21-29, where the one or more prize parameters include one or more of a base prize magnitude, an exponential decay rate, an edge reward multiplier, and a query-specific boosting factor.

Example 31 provides an apparatus including means for performing a method according to any one of examples 21-30.

Example 32 provides a computer program product including instructions which, when executed by a processor, cause the processor to perform a method according to any one of examples 21-30.

Example 33 provides machine-readable storage including machine-readable instructions, which, when executed, cause a computer to implement a method according to any one of examples 21-30.

Example 34 provides a computer program including instructions which, when the computer program is executed by a processing device, cause the processing device to carry out a method according to any one of examples 21-30.

Example 35 provides a computer-implemented system, including one or more processors, and one or more non-transitory computer-readable media storing instructions that, when executed by the one or more processors, cause the one or more processors to perform a method according to any one of examples 21-30.

### Variations and Other Notes

Although the operations of the example method shown in and described with reference to FIGS. are illustrated as occurring once each and in a particular order, it is recognized that the operations may be performed in any suitable order and repeated as desired. Additionally, one or more operations may be performed in parallel. Furthermore, the operations illustrated in FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

For purposes of explanation, specific numbers, materials, and configurations are set forth in order to provide a thorough understanding of the illustrative implementations. However, it is apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges. For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking, or in any other manner.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description and the accompanying drawings.

1. One or more non-transitory computer-readable media comprising instructions, that when executed by one or more processors, cause the one or more processors to perform operations for knowledge graph-based retrieval-augmented generation, the operations comprising:
determining, using a vector similarity search, one or more nodes of a knowledge graph that match a query;
determining, using a symbolic text search, one or more further nodes of the knowledge graph that match the query;
determining one or more initial nodes based on the one or more nodes and the one or more further nodes;
constructing a subgraph based on the one or more initial nodes;
determining one or more prize parameters based on the query;
calculating one or more node prizes and one or more edge prizes for the subgraph based on the one or more prize parameters;
pruning the subgraph based on the one or more node prizes and the one or more edge prizes to generate a pruned subgraph; and
inputting the query and the pruned subgraph into a generative neural network model to generate an answer to the query.

2. The one or more non-transitory computer-readable media of claim 1, wherein determining the one or more further nodes of the knowledge graph that match the query comprises:
extracting one or more entities from the query;
inputting one or more of the query and the one or more entities into a transformer-based neural network to obtain one or more attention scores corresponding to the one or more entities; and
calculating one or more matching scores for one or more nodes of the knowledge graph based on the one or more entities and the one or more attention scores corresponding to the one or more entities.

3. The one or more non-transitory computer-readable media of claim 1, wherein determining the one or more initial nodes based on the one or more nodes and the one or more further nodes comprises:
calculating a fused score of an initial node of the one or more initial nodes based on a minimum of a vector similarity search score corresponding to the initial node and a symbolic text search score corresponding to the initial node.

4. The one or more non-transitory computer-readable media of claim 3, wherein the vector similarity search score is weighted according to a first weight and the symbolic text search score is weighted according to a second weight, the first weight and the second weight being adjustable to prioritize precision or recall.

5. The one or more non-transitory computer-readable media of claim 3, wherein calculating the fused score of the initial node further based on one or more of: a rank position of the initial node, and an overlap status of the initial node.

6. The one or more non-transitory computer-readable media of claim 1, wherein determining the one or more initial nodes based on the one or more nodes and the one or more further nodes comprises:
inputting the query and a description of the one or more nodes and the one or more further nodes into a further transformer-based neural network model to obtain the one or more initial nodes.

7. The one or more non-transitory computer-readable media of claim 1, wherein constructing the subgraph based on the one or more initial nodes comprises:
applying an expansion strategy to construct the subgraph based on the one or more initial nodes and the knowledge graph; and
based on one or more fallback conditions being met, applying an alternative expansion strategy to construct the subgraph based on the one or more initial nodes and the knowledge graph, the one or more fallback conditions comprising one or more of: a timeout condition, and an empty result set being generated.

8. The one or more non-transitory computer-readable media of claim 1, wherein determining the one or more prize parameters based on the query comprises:
inputting the query into a model trained on the one or more initial nodes and the knowledge graph using machine learning to obtain the one or more prize parameters.

9. The one or more non-transitory computer-readable media of claim 1, wherein determining the one or more prize parameters based on the query comprises:
extracting one or more entities from the query; and
inputting one or more of the query and the one or more entities into a model whose model parameters are trained on the one or more initial nodes and the knowledge graph using machine learning to obtain the one or more prize parameters.

10. The one or more non-transitory computer-readable media of claim 1, wherein the one or more prize parameters comprise one or more of a base prize magnitude, an exponential decay rate, an edge reward multiplier, and a query-specific boosting factor.

11. A knowledge graph-based retrieval-augmented generation system, comprising:
one or more processors; and
one or more memories to store a knowledge graph and instructions, wherein the instructions cause the one or more processors to perform operations comprising:
determining, using a vector similarity search, one or more nodes of the knowledge graph that match a query;
determining, using a symbolic text search, one or more further nodes of the knowledge graph that match the query;
determining one or more initial nodes based on the one or more nodes and the one or more further nodes;
constructing a subgraph based on the one or more initial nodes;
determining one or more prize parameters based on the query;
calculating one or more node prizes and one or more edge prizes for the subgraph based on the one or more prize parameters;
pruning the subgraph based on the one or more node prizes and the one or more edge prizes to generate a pruned subgraph; and
inputting the query and the pruned subgraph into a generative neural network model to generate an answer to the query.

12. The knowledge graph-based retrieval-augmented generation system of claim 11, wherein determining the one or more further nodes of the knowledge graph that match the query comprises:
extracting one or more entities from the query;
inputting one or more of the query and the one or more entities into a transformer-based neural network to obtain one or more attention scores corresponding to the one or more entities; and
calculating one or more matching scores for one or more nodes of the knowledge graph based on the one or more entities and the one or more attention scores corresponding to the one or more entities.

13. The knowledge graph-based retrieval-augmented generation system of claim 11, wherein determining the one or more initial nodes based on the one or more nodes and the one or more further nodes comprises:
calculating a fused score of an initial node of the one or more initial nodes based on a minimum of a vector similarity search score corresponding to the initial node and a symbolic text search score corresponding to the initial node.

14. The knowledge graph-based retrieval-augmented generation system of claim 13, wherein the vector similarity search score is weighted according to a first weight and the symbolic text search score is weighted according to a second weight, the first weight and the second weight being adjustable to prioritize precision or recall.

15. A knowledge graph-based retrieval-augmented generation method, comprising:
determining, using a vector similarity search, one or more nodes of a knowledge graph that match a query;
determining, using a symbolic text search, one or more further nodes of the knowledge graph that match the query;
determining one or more initial nodes based on the one or more nodes and the one or more further nodes;
constructing a subgraph based on the one or more initial nodes;
determining one or more prize parameters based on the query;
calculating one or more node prizes and one or more edge prizes for the subgraph based on the one or more prize parameters;
pruning the subgraph based on the one or more node prizes and the one or more edge prizes to generate a pruned subgraph; and
inputting the query and the pruned subgraph into a generative neural network model to generate an answer to the query.

16. The knowledge graph-based retrieval-augmented generation method of claim 15, wherein determining the one or more initial nodes based on the one or more nodes and the one or more further nodes comprises:
inputting the query and a description of the one or more nodes and the one or more further nodes into a further transformer-based neural network model to obtain the one or more initial nodes.

17. The knowledge graph-based retrieval-augmented generation method of claim 15, wherein constructing the subgraph based on the one or more initial nodes comprises:
applying an expansion strategy to construct the subgraph based on the one or more initial nodes and the knowledge graph; and
based on one or more fallback conditions being met, applying an alternative expansion strategy to construct the subgraph based on the one or more initial nodes and the knowledge graph, the one or more fallback conditions comprising one or more of: a timeout condition, and an empty result set being generated.

18. The knowledge graph-based retrieval-augmented generation method of claim 15, wherein determining the one or more prize parameters based on the query comprises:
inputting the query into a model trained on the one or more initial nodes and the knowledge graph using machine learning to obtain the one or more prize parameters.

19. The knowledge graph-based retrieval-augmented generation method of claim 15, wherein determining the one or more prize parameters based on the query comprises:
extracting one or more entities from the query; and
inputting one or more of the query and the one or more entities into a model whose model parameters are trained on the one or more initial nodes and the knowledge graph using machine learning to obtain the one or more prize parameters.

20. The knowledge graph-based retrieval-augmented generation method of claim 15, wherein the one or more prize parameters comprise one or more of a base prize magnitude, an exponential decay rate, an edge reward multiplier, and a query-specific boosting factor.
